(19) United States
(12) Patent Application Publication
(10) Pub. No.: US 2010/0165451 A1
(43) Pub. Date: Jul. 1, 2010

(54) OPTICAL DEFLECTOR AND OPTICAL DEFLECTING BOARD

(75) Inventors: Chang-Sheng Chu, Hsinchu City (TW); Hsiu-Hsiang Chen, Hsinchu County (TW); Yu-Tang Li, Taipei County (TW); Chun-Chuan Lin, Hsinchu City (TW); Chih-Hsun Fan, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/477,891

(22) Filed: Jun. 3, 2009

(30) Foreign Application Priority Data
Dec. 31, 2008 (TW) 97151889

(51) Int. Cl. G02F 1/29

(52) U.S. Cl. 359/316; 359/315

(57) ABSTRACT

An optical deflector includes a substrate, an electrode layer on the substrate, an insulating layer at a predetermined peripheral region on the electrode layer, exposing the central region of the electrode layer. First electrode sandwiched wall is on the insulating layer. Second electrode sandwiched wall is on the insulating layer corresponding to the first electrode sandwiched wall. A pair of insulating walls is between the first electrode sandwiched wall and the second electrode sandwiched wall in enclosing to form an inner space. An outer wall encloses the pair of insulating layers, the first and the second electrode sandwiched walls at outside. A cap layer covers on the outer wall. A first liquid is filled into the inner space in contact with the electrode layer. A second liquid is filled into the inner spacer without solving to each other and forms a liquid interface.

### CROSS-REFERENCE TO RELATED APPLICATION

This application claims the priority benefit of Taiwan application serial no. 97151889, filed on Dec. 31, 2008. The entirety of the above-mentioned patent application is hereby incorporated by reference herein and made a part of this specification.

### BACKGROUND OF THE INVENTION

1. Technical Field

The present disclosure relates to optical deflector. More particularly, the present disclosure relates to liquid optical deflector.

2. Description of Related Art

3. The Prior Art

The electrowetting phenomenon has been well known in the art. In the electrowetting phenomenon, when an applied voltage between two liquids is changed, the surface tension is changed too, resulting in movement of the liquid. In further researches, if the metal surface of the electrode is formed with an insulation film with a thickness of several microns, the operation reliability can be improved. The electrode can be protected from damage. This improved technology is then called electrowetting-on-dielectric (EWOD).

The EWOD technology can be, for example, used in Lab-on-a-chip (LOC) or optical applications. The optical application may have liquid lense and electronic paper. The operation mechanism of the electrowetting phenomenon is as follows. For example, a liquid drop is disposed on a metal substrate with a thin insulation layer thereon. Then, a voltage is applied on the metal substrate, the contact angle of the liquid drop and the metal substrate can be changed. When this liquid drop is used as the optical lens, two liquids with equal density are used. One liquid is insulating and another liquid is conductive. Due to the change of voltage, the curvature of the interface between the two liquids is accordingly changed, resulting in the change of lens focus.

In the conventional applications, for example, U.S. Pat. No. 6,369,954 has proposed an application. FIG. 1 is a cross-sectional view, schematically illustrating a conventional lens with variable focus. In FIG. 1, A drop of an insulating liquid 11 is located on the internal surface of a wall of a dielectric chamber 12 filled with a conductor liquid 13. The insulating liquid 11 and the conductor liquid 13 are both transparent, not miscible, have different optical indexes and have substantially the same density. The dielectric 12 naturally has a low wetting with respect to the conductor liquid 13. A surface treatment 14 insuring a high wetting of the wall of the dielectric chamber with respect to the conductor liquid 13 surrounds the contact region 15 between the insulating liquid drop 11 and the wall of chamber 12. The surface treatment 14 maintains the positioning of drop 11, preventing the insulating liquid from spreading beyond the desired contact surface. When the system is at rest, the insulating liquid drop 11 naturally takes the shape designated by reference A. When a voltage V is established between electrodes 16 and 17, an electrical field is created which, according to the above mentioned electrowetting principle, will increase the wetting of region 15 with respect to conductor liquid 13. As a consequence, conductor liquid 13 moves and deforms the insulating liquid drop 11 into the shape designated by reference B.

Although several other disclosures have been proposed by, for example, WO 2004/051323 and U.S. Pat. No. 7,245,439, the conventional liquid optical device basically needs to assemble several parts into the device. Alternatively in conventional structure, the indium tin oxide (ITO) electrode and the hydrophobic insulating layer are coated on an inner surface of a glass cavity, and then the glass cavity is adhered to the lower transparent substrate.

Design for the structure of liquid optical deflector and its various applications are still under development.

### SUMMARY

According to one embodiment of the present disclosure, an optical deflector includes a substrate, an electrode layer on the substrate, an insulating layer on a predetermined peripheral region of electrode layer, exposing the central region of the electrode layer. A first electrode sandwiched wall is on the insulating layer. A second electrode sandwiched wall is on the insulating layer corresponding to the first electrode sandwiched wall. A pair of insulating walls is between the first electrode sandwiched wall and the second electrode sandwiched wall in enclosing to form an inner space. An outer wall encloses the pair of insulating walls, the first and the second electrode sandwiched walls at outside. A cap layer covers on the outer wall. A first liquid is filled into the inner space in contact with the electrode layer. A second liquid is filled into the inner spacer without solving to each other and forms a liquid interface.

According to one embodiment of the present disclosure, an optical deflecting panel includes a substrate, an electrode layer on the substrate, an insulating layer on the electrode layer, exposing a plurality of regions of the electrode layer. A plurality of first electrode sandwiched walls are on the insulating layer. A plurality of second electrode sandwiched walls are disposed on the insulating layer, opposite to the first electrode sandwiched walls respectively, to form a plurality of structural units. A plurality of pairs of insulating walls is respectively disposed between the first electrode sandwiched walls and the second electrode sandwiched walls within the structural units, so as to form a plurality of spaces. An outer wall is disposed on the substrate, surrounding the structural units. A top cap layer covers over the outer wall. A first liquid is filled in the inner space of each structural unit and contacts the electrode layer. A second liquid is filled in the inner space of each structural unit and is not solved in the first liquid to each other, so as to form a liquid interface.

According to one embodiment of the present disclosure, an optical deflector, includes a first substrate; a first electrode layer, disposed on the first substrate; a second substrate; and a second electrode layer, disposed on the second substrate. Further, a first insulating layer is disposed on a predetermined peripheral region of the first electrode layer, exposing a central region of the first electrode layer. A second insulating layer is disposed on a predetermined peripheral region of the second electrode layer, exposing a central region of the second electrode layer. A first electrode sandwiched wall is disposed between the first insulating layer and the second insulating layer. A second electrode sandwiched wall is disposed between the first insulating layer and the second insulating layer, against the first electrode sandwiched wall, wherein an inner space is formed between the first electrode sandwiched wall and the second sandwiched wall. A first liquid and a second liquid are filled in the inner space. A third liquid is filled in the inner space between the first liquid and the second liquid without solving to each other, so as to form a first liquid interface and a second liquid interface.

According to one embodiment of the present disclosure, an optical deflecting panel, includes a first substrate; a first electrode layer, disposed on the first substrate; a second substrate; and a second electrode layer, disposed on the second substrate. Further, a plurality of first electrode sandwiched walls is disposed between the first insulating layer and the second insulating layer. A plurality of second electrode sandwiched walls is disposed between the first insulating layer and the second insulating layer, respectively against the first electrode sandwiched walls to form a plurality of structural units, wherein each of the structural units has an inner space. A first liquid is filled in the inner space of each of the structural units. A second liquid is filled in the inner space of each of the structural units. A third liquid is filled in the inner space of each of the structural units between the first liquid and the second liquid without solving to each other, so as to form a first liquid interface and a second liquid interface.

According to one embodiment of the present disclosure, an optical deflecting panel includes a plurality of liquid optical deflectors arranged in an array. Each of the liquid optical deflectors receives an incident light. The incident light is divided by a tilting state of a liquid interface in each of the liquid optical deflectors into a transmitting light at first direction and a reflection light at a second direction.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a cross-sectional view, schematically illustrating a conventional lens with variable focus.

FIG. 2 is a side cross-sectional view, schematically illustrating an optical defector, according an embodiment of the disclosure.

FIGS. 3-5 are cross-sectional views, schematically illustrating an optical defector in operations, according an embodiment of the disclosure.

FIG. 6 is a side cross-sectional view, schematically illustrating another optical defector, according another embodiment of the disclosure.

FIG. 7A-7B are two cross-sectional views, schematically illustrating the optical defector in FIG. 6.

FIG. 8 is a drawing, schematically illustrating an application of the optical defector, according another embodiment of the disclosure.

FIG. 9 is a drawing, schematically illustrating a cross-sectional structure of an optical defector, according another embodiment of the disclosure.

FIG. 10 is a drawing, schematically illustrating an optical deflecting panel, according another embodiment of the disclosure.

FIG. 11 is a drawing, schematically illustrating the absorption coefficient of water to the light in different wavelength.

FIG. 12 is a drawing, schematically illustrating a mechanism of the optical deflecting panel being used in window.

FIG. 13 is a planar view, schematically illustrating an optical deflecting panel, according an embodiment of the disclosure.

FIG. 14 is a planar view, schematically illustrating an optical deflecting panel, according another embodiment of the disclosure.

FIG. 15A-15D are cross-sectional views, schematically illustrating another optical deflector, according to an embodiment of the disclosure.

FIGS. 16-18C are drawings, schematically illustrating the light paths for the optical deflecting panel.

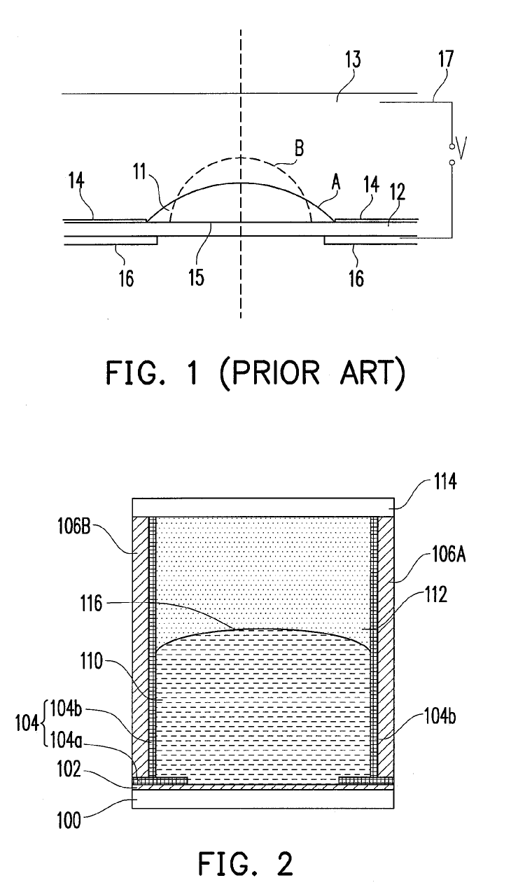

### DESCRIPTION OF THE PREFERRED EMBODIMENTS

In the disclosure, a liquid optical deflector is proposed, in which an electrowetting phenomenon is produced based on two liquids of water and oil, for example. The two liquids have about the same density bit not solved to each other, in which water is electric conductive and the oil is electric insulating. According to the electro-wetting technology, the two electrodes can be applied with voltages to form an electric field, so as to further change the contact angle of the water surface and then a tilting surface of the liquid can be controlled, so as to deflect or reflect the light. Each optical deflector, such as deflecting device, basically includes two electrodes and an insulating layer, wherein by controlling the voltages, the contact angle between the liquids can be changed.

Since the two electrodes have different indices of refractions, by the tilting angle of the liquid surface based on optical design, when the light is passing water, water can receive or reflect the IR while the light is reflected or deflected. The optical deflecting devices can, for example, be arranged into an array, implemented on a window. By control of optical deflecting device and the array, the IR in the sun light, causing heat in the room, can be absorbed or deflected. At the same time, the visible light can be deflected into the inner room for illumination. Each unit (deflecting device) of the optical deflecting apparatus can be controlled to have a liquid titling angle, so that the sunlight in different angles entering the optical deflecting apparatus can be deflected room to increase the illumination. Since the sunlight can be divided into a near infra red with wavelength of 0.75-1.4 microns, short-wavelength infra red with wavelength of 1.4-3 microns, middle-wavelength infra red with wavelength of 3-8 microns, long-wavelength infra red with wavelength of 8-15 microns, and far infra red with wavelength of 15-1000 microns. The sunlight has 49% in infrared. The middle-wavelength infra red being continuously radiated is the main portion in the sunlight absorbed by the Earth during day and night. Most of the infra red can be absorbed and reflect by water. The visible light is deflected into the room. The optical deflecting apparatus can also reflect the divergent light back into the room, so that the illumination within room is improved.

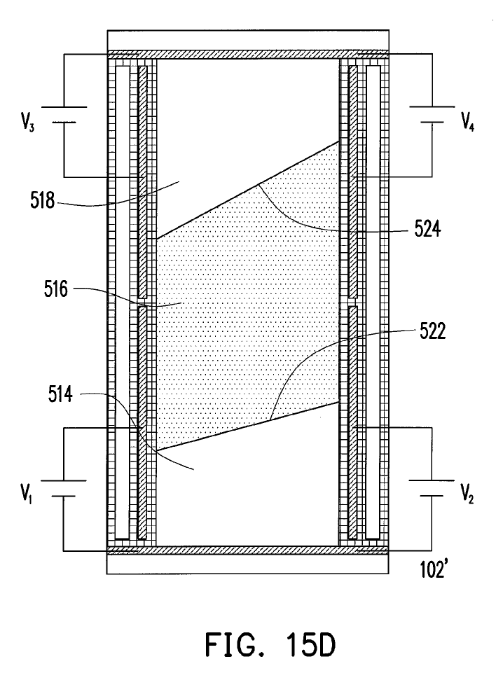

Further speaking, the liquids are not just limited to the two liquids. Three liquids or more without solving to each other can be used to form multiple liquid interfaces. By controlling tilting angle of each liquid interface, the traveling direction of incident light can be changed. In order to have at least three liquids, for example, three liquids insolvable to each other can be directly filled into the same unit for replacing the two liquids. Embodiment in FIG. 15 will more specifically describe. The electrode wall can be operated in the same voltage or in multiple voltages. In other words, the manners of voltage control can be changed depending on different filling liquids.

Several embodiments are provided for descriptions but the disclosure is not just limited to the embodiments. In addition, the embodiments can be properly combined into another embodiment.

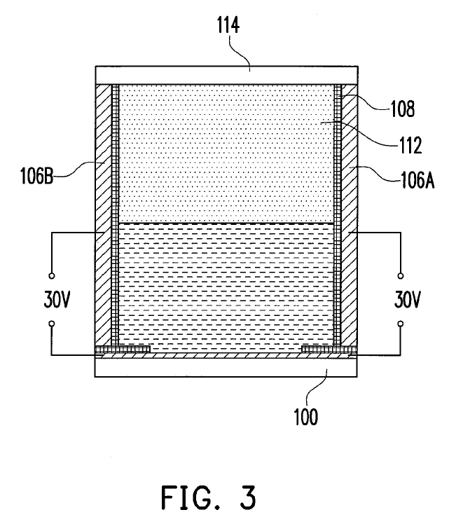

The structure of the liquid optical deflector in two liquids is described first. FIG. 2 is a side cross-sectional view, schematically illustrating a liquid optical defector, according an embodiment of the disclosure. In FIG. 2, liquid optical deflector can include, for example, a lower transparent substrate 100. An electrode layer 102 is disposed on the substrate 100 to serve as a common electrode, for example. The electrode layer 102 can be applied a ground voltage in actual operation, for example. An insulating layer 104 including an insulating bottom layer 104a and insulating wall 104b, disposes on the electrode layer 102. The insulating bottom layer 104a is on the electrode layer 102a. A predetermined central region of the electrode layer 102 is intended to be exposed. The insulating bottom layer 104a is at the periphery of the central region to expose the central region. A first electrode wall 106A and a second electrode wall 106B are disposed over and righting up from the substrate 100. The first electrode wall 106A and the second electrode wall 106B are insulating from the electrode layer 102 by the insulating layer 104. The electrode wall 106A, 106B can be, for example, conductive photopolymer. The insulating wall 104b is disposed on a surface of the first electrode wall 106A and 106B. Basically, the first electrode wall 106A and the second electrode wall 106B form a parallel pair of electrodes for later use to control the liquid interface in electrowetting mechanism. The material for the insulting layer 104b can be, for example, hydrophobic, so that the electrowetting phenomenon can be easier controlled.

A liquid 110 is filled in the containing space in contacting with the electrode layer 102 on the substrate 100. The liquid 110 includes, for example, water or conductive solution. Another liquid 112 is filled in the containing space to have an interface with the liquid 110 without solving to each other. The liquid 112 can include, for example, oil or insulating liquid. However, in general, one of the two liquids is conductive and the other one is insulating, for example. A transparent cap layer 114 seals over the containing space to form an optical deflector unit. The tow kinds of liquids can be chosen to form the interface plane, of which the tilt angle of the interface can controlled. Further, the densities of the two liquids, preferably, are substantially the same. As a result, the deflector is not affected by the gravity force.

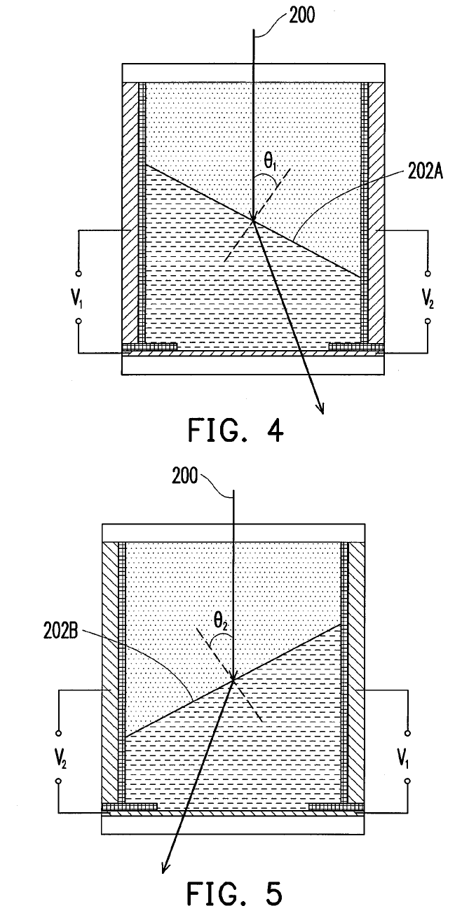

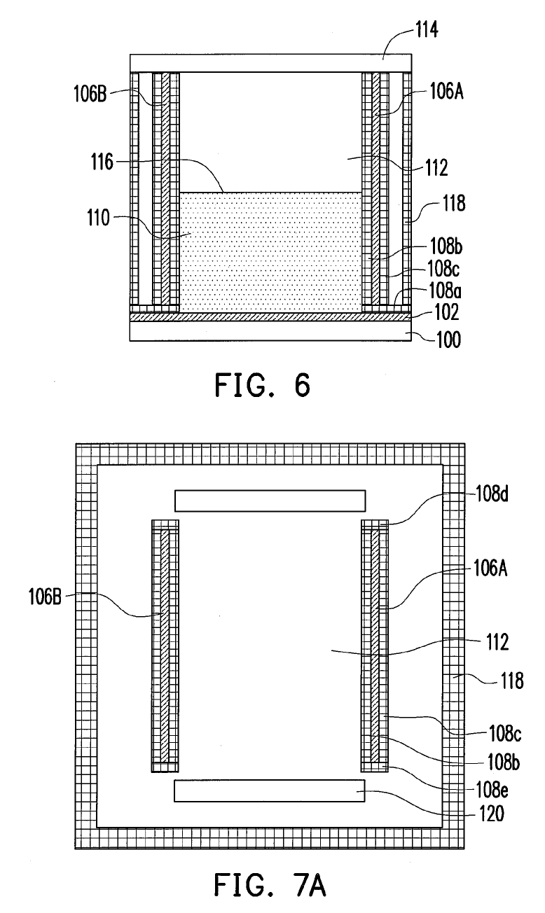

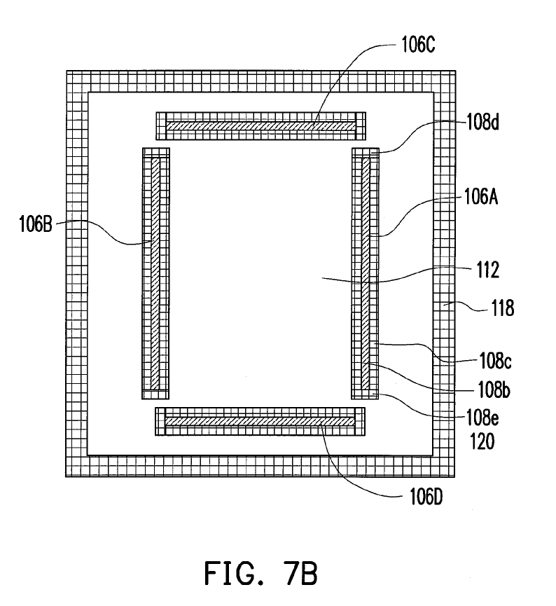

FIGS. 3-5 are cross-sectional views, schematically illustrating an optical defector in operations, according an embodiment of the disclosure. For example, the operation is described. In FIG. 3, the electrode 106A and the electrode 106B with respect to the common electrode 102 are respectively applied with an equal voltage, such as the voltage at 30V. In this situation, there is no electric field created. The angle of the liquid interface remains horizontal. For a perpendicularly incident light, the traveling direction is not deflected. In FIG. 4, for example, when the electrode wall 106A is applied with a voltage V₂ and the electrode wall 106B is applied with a voltage V₁, an electric field is created. According to the electrowetting phenomenon, the liquid interface 202A is tilted. The two liquids have different indices of refractions. With respect to the liquid interface 202A, the incident light 200 has an incident angle θ₁, then the outgoing light is deflected to right. In FIG. 5, when the electrode wall 106A is applied with a voltage V₁ and the electrode wall 106B is applied with a voltage V₂, another electric field is created. According to the electrowetting phenomenon, the liquid interface 202B is tilted. With respect to the liquid interface 202B, the incident light 200 has an incident angle θ₂, then the outgoing light is deflected to left. Generally, the liquid interface between the first liquid and the second liquid has an angle. This angle can be controlled by applying a first voltage on the electrode wall 106A and a second voltage on the second electrode wall 106B. Depending on the value of the applied voltages on the electrode walls, the tilt angle of the liquid interface can be controlled. At time situation, the incident light can be deflected to the desired direction in operation.

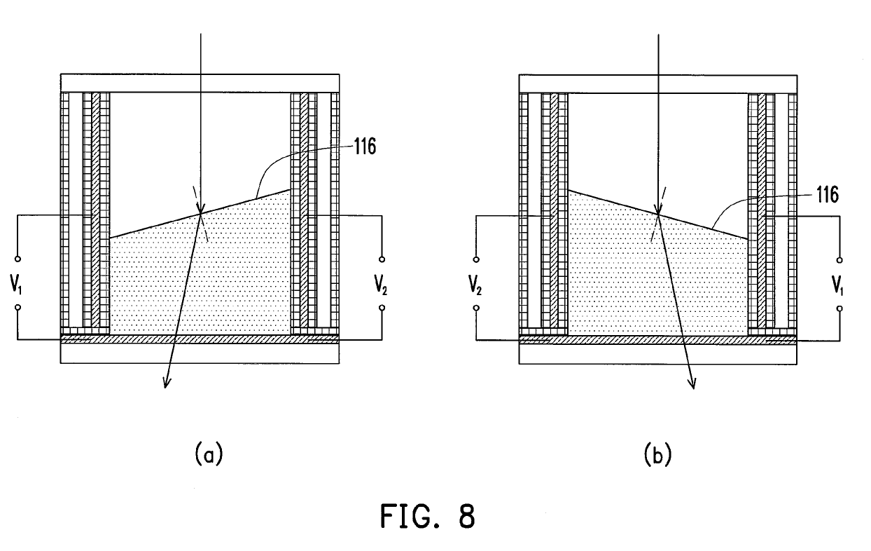

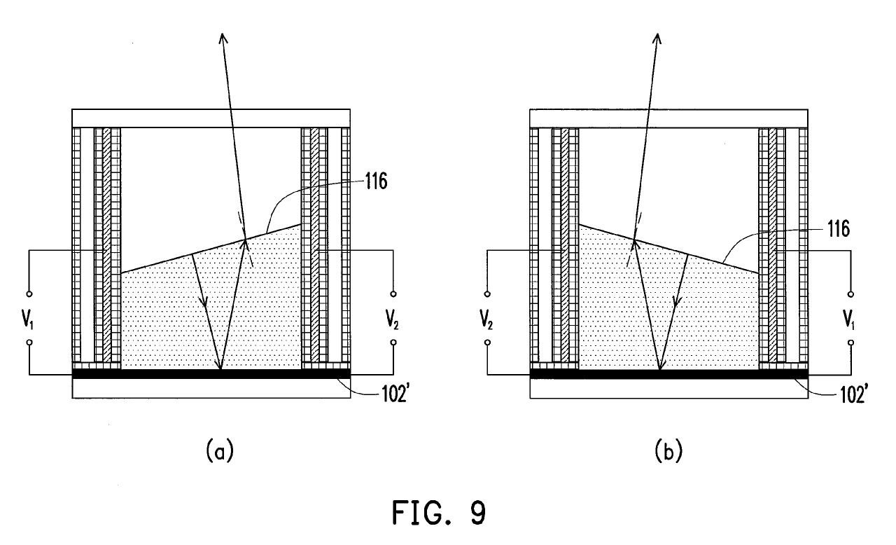

The foregoing liquid optical deflector is not the only design. FIG. 6 is a side cross-sectional view, schematically illustrating an optical defector, according another embodiment of the disclosure. FIG. 7A-7B are two cross-sectional views, schematically illustrating an optical defector in FIG. 6. In FIGS. 6 and 7A, the embodiment of optical deflector, for example, includes a substrate 100. Taking the substrate 100 as the base, the optical deflector further includes an electrode layer 102 disposed on the substrate 100. A bottom insulating layer 108a is disposed on the electrode layer 102 at a peripheral region and exposes a central region of the electrode layer 102. A first electrode sandwiched wall is on the insulating layer 108a. The first electrode sandwiched wall, for example, includes a first inner insulating wall 108b, electrode wall 106A and a first outer insulating wall 108c. The bottom insulating layer 108a, the inner insulating wall 108b, the outer insulating wall 108c, and the side insulating layers 108d, 108e are insulating layers to surround the electrode wall 106A, so as to protect the electrode wall 106A. The inner insulating wall 108b is on the bottom insulating layer 108a extending upward. The electrode wall 106A is on the inner insulating wall 108b. The outer insulating wall 108c is on the electrode wall 106A. Another electrode wall 106B is like the electrode wall 106A, sandwiched between the inner insulating wall 108b and the outer insulating wall 108c to form a second electrode sandwiched wall. A pair of insulating walls 120 (see FIG. 7A) is between the first electrode sandwiched wall and the second electrode sandwiched wall to form an inner space. The inner space can be a close spacer or an open space. If the pair of insulating wall 120 is fully contacting the first fist electrode sandwiched wall and the second electrode sandwiched wall, the space is a close space. If the pair of insulating walls 120 is separating the first fist electrode sandwiched wall and the second electrode sandwiched wall, the space is the open space, as shown in FIG. 7A. Certainly, the number of the electrode sandwiched walls is not limited to two and then can be at least two, to have control of electrowetting phenomenon. The number of the electrode sandwiched walls can be associating with the disposition of multiple-side arrangement to control the titling state of the liquid interface 116. For example, FIG. 7B illustrates an embodiment with four electrode sandwiched walls. By the same manner to implement the electrode wall 106A, the electrode wall 106C and the electrode wall 106D are implemented.

An outer wall 118 surrounds outside of the insulating wall 120, the first fist electrode sandwiched wall and the second electrode sandwiched wall. A top cap layer 114 covers the outer wall 118. Alternatively, it can cover on the electrode sandwiched wall, depending on various options in actual need. A first liquid 110 is filled in the foregoing inner space and contacts the electrode layer 102. A second liquid 112 is filled in the foregoing inner space without solving with the first liquid to each other, so that a liquid interface is created.

In FIG. 7, an inner space formed by the insulating wall 120 and the two electrode sandwiched walls is an open space, extending to the outer wall 118. These two liquids 110, 112 are contained by the outer wall. The two liquids 110, 112 can be liquid and oil, for example without solving to each other and having about the same density. In the further applications later, water can absorb the infrared. Water and oil are different indices of refraction with refraction effect, so as to have various applications. However, the insulating wall 120 is helpful to have the inner space, and is useful for the tilt stat of the liquid interface but not the absolute condition in need.

The electrode 102 can serve as a common ground to form voltage biases to the electrode layer 106A and the electrode layer 106B, so as to control the tilted state of the liquid interface 116.

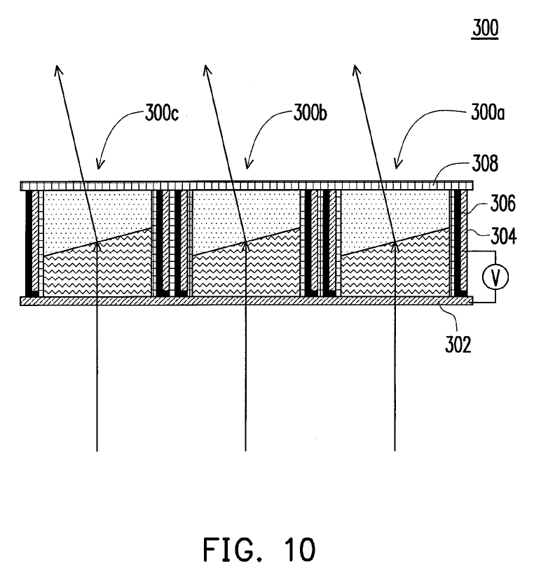

FIG. 8 is a drawing, schematically illustrating an application of the optical defector, according another embodiment of the disclosure. In FIG. 8(a), if the substrate, electrode layer and the top cap layer are light transparent, proper voltages can be applied on the electrode layer 106A, 106B to control the tilted state of the liquid interface 116. Since the two liquids have different indices of refraction, the passing light in traveling is deflected and led to a desired direction. As a result, in FIG. 8(b), if the voltage is changed, the tiled angle of the liquid interface 116 is changed.

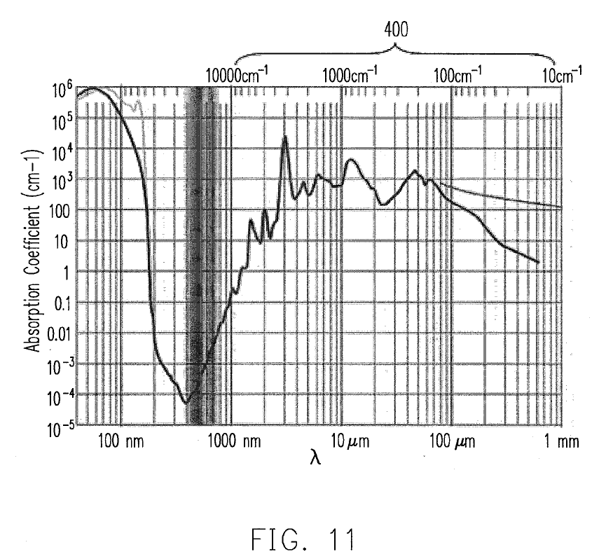

FIG. 9 is a drawing, schematically illustrating a cross-sectional structure of an optical defector, according another embodiment of the disclosure. In FIG. 9(a), in the structure of the optical deflector, for example, if the electrode layer 102′, such as metal material, has capability of reflection, or a reflection layer disposed on the electrode layer 102′, the incident light to the electrode layer 102′ can be reflected and deflected by the liquid interface 116 onto the predetermined traveling direction. Likewise, in FIG. 9(b), changing the control voltage can change he traveling direction of the refection light.

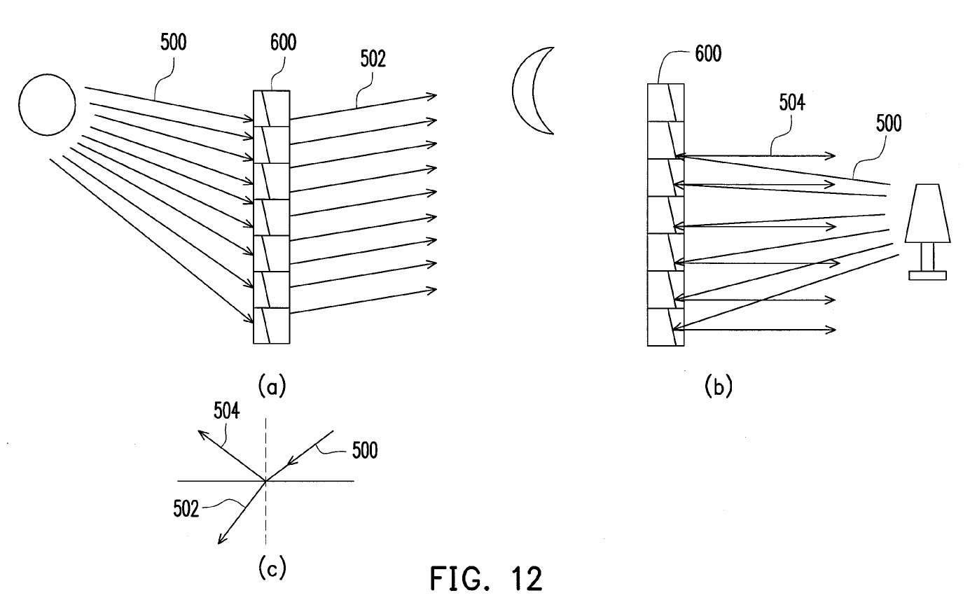

Using foregoing optical deflector, it can be assembled to form a deflecting panel in a large area and, for example, implemented on the window to improve the window performance. FIG. 10 is a drawing, schematically illustrating an optical deflecting panel, according another embodiment of the disclosure. In FIG. 10, for the basic structure, the deflecting panel 300 uses multiple optical deflectors to form a panel. Taking three optical deflectors 300a, 300b, and 300 as an example, they are adjacently disposed on the common electrode 302. Here, the common electrode 302 in the embodiment as previously described can be, for example, the transparent conductive material, disposed on the substrate. However, it is not necessary to be limited to this structure. It can use the electrode layer 306, he insulating wall 304 and the top cap layer 308 to form many units in an array. For the incident light for such a large area, with respect to the sunlight as the example, the deflecting panel receives the light in a large area and deflects to a direction. Further, since the sunlight is parallel according to the far distance between the sun and the earth, the tilting angles of the liquid interface for each of the optical deflectors 300a, 300b, 300c can be the same. However, if it is needed, the each optical deflector 300a, 300b, 300c can be separately controlled. Here, the control circuit can be made by the usual technology and can be understood by the one with ordinary skill. The detail is not further described.

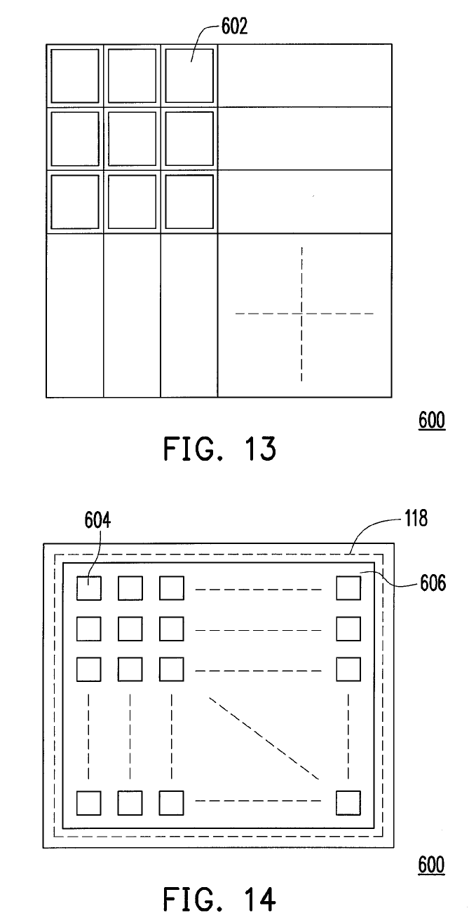

FIG. 11 is a drawing, schematically illustrating the absorption coefficient of water to the light in different wavelength. In general, the IR portion of the sunlight just is producing heat but not changing the illumination of visible light. When the deflecting panel is implemented on the window for an application, it can allow the light into enter the room but also the infrared is also intended to be excluded to enter the room. Water at the infrared region 400 has absorption effect, apparently. Therefore, the optical deflector of the disclosure can use, for example, water as the liquid, so as to isolate the infrared. Likewise, the effect to isolate the infrared can be done by applying and modification for the absorption coefficient in different wavelengths with respect to different liquids.

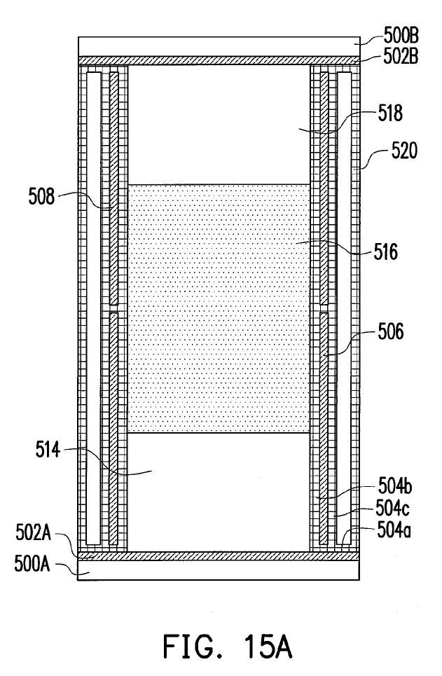

FIG. 12 is a drawing, schematically illustrating a mechanism of the optical deflecting panel being used in window. In FIG. 12(c), for the interface with different indices of refraction, the refraction phenomenon is shown. The incident light 500 from the first material enters the second material, it has the refraction light 502. Depending on the incident angle, a portion of the light is reflected as the reflection light 504. In application of FIG. 12(a), the application is window as an example. When the incident light 500, such as the sunlight, transmits the window and enter the room, if the window is implemented with the deflecting panel 600, then the deflecting panel 600 can deflect a portion of the refraction light 502 into the room. The intensity of the reflection light 504 is larger as the incident angle is larger. If the light is incident from the liquid with larger index of refraction, a internal total reflection can occur.

Here as understandable, since the sunlight is parallel, the incident angle is the same. However, the incident light 500 is a point-like light source, then the incident angle for each optical deflector in the deflecting panel 600 has little difference. If the deflecting panel 600 is designed to allow each optical deflector to be separately controlled or several optical deflectors in block region to be separately controlled, then an intended illumination can be adjusted out.

For the further example in the night, as shown in FIG. 12(b), since the illumination at outside is insufficient to provide the illumination inside the room, oppositely, the light produced by the interior lamp is easily transmitting to the outside. By the adjustment of the deflecting panel 600, a portion of the refection light is reflected backed into the room for increasing the interior illumination.

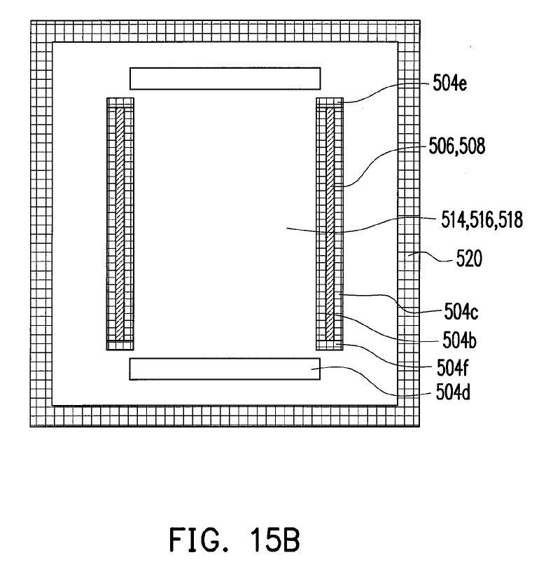

FIG. 13 is a planar view, schematically illustrating an optical deflecting panel, according an embodiment of the disclosure. In FIG. 13, the deflecting panel 600 is, for example, formed by several optical deflectors 602, each of which is like the structure in FIG. 3. In the embodiment, the optical deflector 602 is separate unit with the two liquids sealed in a space.

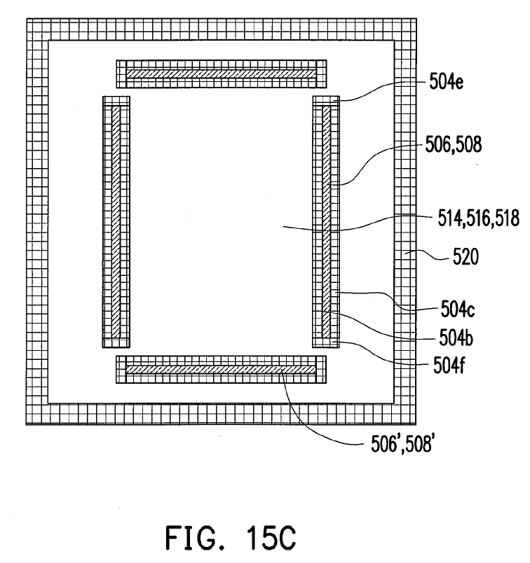

FIG. 14 is a planar view, schematically illustrating an optical deflecting panel, according another embodiment of the disclosure. In FIG. 14, the deflecting panel 600 is, for example, formed by several optical deflectors 604, such as the structure in FIG. 7. In the embodiment, the deflecting unit 604 is in an open space. Therefore, the outer wall 118 is used to contain the two liquids 606. Since the space for containing the liquid in each unit of the deflecting unit 604 is connected, the liquid is filled in global. In this manner, the filled liquid in each unit is the same, and it has the advantage in convenient fabrication. However, how to assemble several optical deflectors into a deflecting panel in large area can be in various ways without limiting to a specific way.

With the same mechanism, the previous embodiments with two liquids to form one liquid interface can be modified to have more liquid interfaces. An example with three liquid to form two liquid interfaces is provided for descriptions. Since there are two liquid interfaces to be controlled, the electrode structure for control needs to be properly modified.

FIG. 15A-15D are cross-sectional views, schematically illustrating another optical deflector, according to an embodiment of the disclosure. FIG. 15A is a longitudinal cross-sectional view of optical deflector. FIG. 15B is a transverse cross-sectional view of optical deflector. FIG. 15C is another transverse cross-sectional view of optical deflector. FIG. 15D is the operational mechanism of the optical deflector. In FIG. 15A, the three liquids of the embodiment are, for example, two electric conductive liquids 514, 518 and insulating liquid 516 between the two liquids 514, 518. However, the disclosure is not limited to just three liquids, and the electrode is implemented to control the liquid. Several embodiments are provided. The electric conductive liquid can be, for example, water, and the insulating liquids can be, for example, oil. Since the water and the oil are not solved to each other and therefore form two liquid interfaces 522, 524. In order to adapt the liquids and control the liquid interfaces, the liquid optical deflector, as previously described, needs electrode structure and a containing space. However, more liquid interfaces nee to be controlled, the electrode structure needs to be changed.

The structure of optical deflector includes a substrate 500A, for example. The substrate 500A is transparent material, allowing the light to enter. Electrode layer 502A is disposed on the substrate 500A. Electrode layer 502A can be, for example, transparent conductive material. The substrate 500A is serving as lower cap layer. In addition, an upper cap layer, like the lower cap layer, includes a substrate 500B and transparent electrode layer 502B on the substrate 500B. The upper cap layer and the lower cap layer can be exchanged. The insulating layer 504a is disposed on the electrode layer 502A and the electrode layer 502B at the peripheral region to expose the central regions of the electrode layers 502A, 502B. A first electrode sandwiched wall is disposed between the two insulating layers 504a. Another electrode sandwiched wall is disposed between the two insulating layers 504a, against the first electrode sandwiched wall. The electrode sandwiched wall holds the electrode walls 506, 508. For example, the insulating layer 504c is serving as the outer wall. When considering the isolation and protection after the liquids 514, 516, 518 are filled, the electrode sandwiched wall can further include an insulating wall 504b to serve as the inner insulating wall. The space between two electrode sandwiched walls forms an inner space. In addition, the side insulating wall 504e, 504f can be further included to fully enclose the electrode wall for further protection. Liquid 514 can be, for example, conductive water, filled in the inner space. Another liquid 518 can be, for example, also the conductive water filled in the inner space. Another liquid 516 can be, for example, insulating oil, filled in the inner space between the two liquids 514, 518 and is not solved to each other for forming liquid interfaces 522, 524. In other words, to control multiple liquid interfaces, it needs the corresponding electrode structure. Further in accordance with the need, the insulating wall 504d can be further included to define the inner space for each unit, respectively. The inner space can be a close space or an open space. In FIG. 15B as an embodiment, the inner space is an open space extending to the outer wall 520. Further, the two electrode walls 506, 508 at up and down are implemented oppositely, as an example. However, as described in FIGS. 7A-7B, the number of electrode walls is not limited to two pairs. In FIG. 15C, there are four electrode walls as an example, the upper electrode can further include two electrode wall 506′ and the lower electrode can further include another two electrode wall 508′.

In FIG. 15D, the operation mechanism is using the electrode walls 506, 508 with the shared electrode layers 502A, 502B to respectively form the voltages V1, V2, V3, and V4. By control quantities of the voltages V1, V2, V3, and V4, the tilt angles of the liquid interfaces 522 and 524 can be controlled. Multiple optical deflectors can form an optical deflecting panel, which can have application at window. Due to more liquid interfaces, the deflection direction can be more efficiently adjusted.

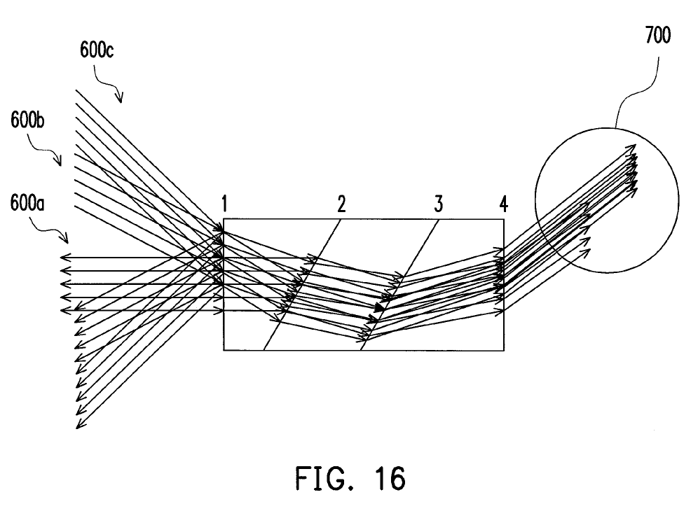

FIGS. 16-18C are drawings, schematically illustrating the light paths for the optical deflecting panel. In FIG. 16, the incident angles can be different. For example, the incident lights 600a, 600b and 600c at angles 0°, 30° and 60° pass the four interfaces 1-4 of the optical deflector and the IR can be filtered out. By adjusting the interfaces 3 and 2, the light can be about at the same direction, so as to obtain the visible light while the IR is filtered. The interface 1 between the substrate and the air can be further coated with the optical film to have better filtering effect of IR.

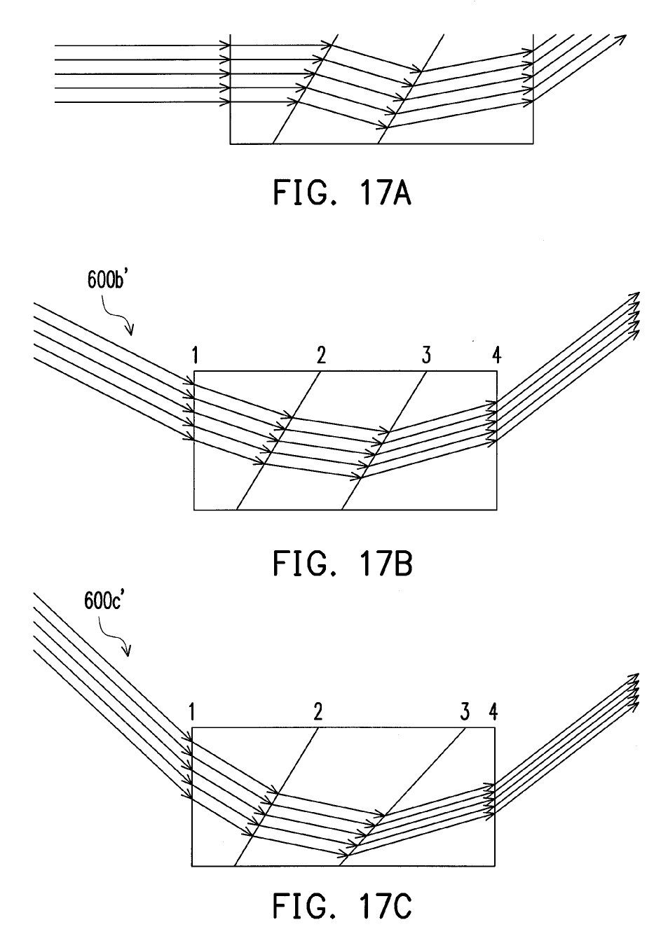

FIGS. 17A-17C are showing the schematic light paths for the visible incident lights 600a′, 600b′, and 600c′ at angles of 0°, 30° and 60°. Taking the structure in FIG. 15, as the base, by controlling the two liquid interfaces 2 and 3, the output visible light 700 are emitting at about the same direction while the incident angles of the light can allow a range in change. In this manner, when it is applied to the window, it has more adjusting range.

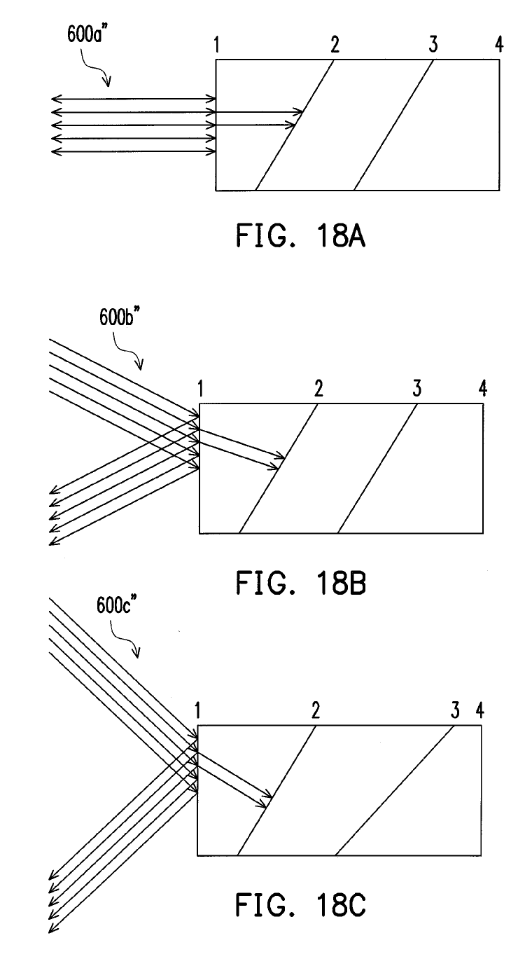

FIGS. 18A-18C are showing the schematic light paths for the IR incident lights 600a″, 600b″, and 600c″ at angles of 0°, 30° and 60°. Since the interface 1 has been coated with IR reflection film, so that most of the IR can be reflected away. A portion of the IR entering the optical deflector can be further absorbed by the water liquid. As a result, almost no IR passes.

Alternatively, if the coating film is the UV film, then the UV is reflected. The IR can be absorbed by the water liquid, so as to have more filtering efficiency.

The foregoing design uses multiple liquid interfaces with the corresponding electrode structures. For the practical design, it is not limited to the provided embodiments. The selection of liquids is not limited to the form of water/oil/water.

It will be apparent to those skilled in the art that various modifications and variations can be made to the structure of the present disclosure without departing from the scope or spirit of the disclosure. In view of the foregoing descriptions, it is intended that the present disclosure covers modifications and variations of this disclosure if they fall within the scope of the following claims and their equivalents.

What is claimed is:

1. An optical deflector, comprising:
a substrate;
an electrode layer, disposed on the substrate;
an insulating layer, disposed on a predetermined peripheral region of the electrode layer, exposing a central region of the electrode layer;
a first electrode sandwiched wall, disposed on the insulating layer;
a second electrode sandwiched wall, disposed on the insulating layer, corresponding to the first electrode sandwiched wall, wherein an inner space is formed between the first electrode sandwiched wall and the second electrode sandwiched wall;
an outer wall, enclosing the first and the second electrode sandwiched walls at outside;
a cap layer, covering on the outer wall;
a first liquid, filled into the inner space in contact with the electrode layer; and
a second liquid, filled into the inner spacer without solving with the first liquid to each other and forms a liquid interface.

2. The optical deflector of claim 1, wherein the first electrode sandwiched wall comprises:
a first inner insulating wall, on the insulating layer, extending upward;
a first electrode wall, on the first inner insulating layer; and
a first outer insulating wall, on the first electrode wall, wherein the first electrode wall is sandwiched between the first inner insulating wall and the first outer insulating wall;
wherein the second electrode sandwiched wall comprises:
a second inner insulating wall, on the insulating layer, extending upward;
a second electrode wall, on the second inner insulating layer; and
a second outer insulating wall, on the second electrode wall at an outer side, wherein the second electrode wall is sandwiched between the second inner insulating wall and the second outer insulating wall.

3. The optical deflector of claim 1, further comprising an insulating wall, coupled with the first electrode sandwiched wall and the second electrode sandwiched wall to form the inner space as a close space.

4. The optical deflector of claim 1, further comprising an insulating wall, coupled with the first electrode sandwiched wall and the second electrode sandwiched wall to form the inner space as an open space.

5. The optical deflector of claim 1, wherein the first liquid and the second liquid are water and oil.

6. The optical deflector of claim 1, wherein the electrode layer is used as a common electrode, coupled with the first electrode sandwiched wall and the second electrode sandwiched wall to produce a voltage bias, for controlling a tilting state of the liquid interface.

7. The optical deflector of claim 1, wherein the electrode layer has a reflection layer or the electrode layer is a metal layer, so as to have capability for reflecting light.

8. The optical deflector of claim 1, wherein the substrate, the electrode layer and the top cap layer are light transparent.

9. An optical deflecting panel, comprising:
a substrate;
an electrode layer on the substrate;
an insulating layer on the electrode layer, exposing a plurality of regions of the electrode layer;
a plurality of first electrode sandwiched walls, disposed on the insulating layer;
a plurality of second electrode sandwiched walls, disposed on the insulating layer, opposite to the first electrode sandwiched walls, respectively, to form a plurality of structural units, wherein a plurality of spaces is formed between the first electrode sandwiched walls and the second electrode sandwiched walls;
an outer wall, disposed on the substrate, surrounding the structural units;
a top cap layer, covering over the outer wall;
a first liquid, filled in the inner space of each structural unit and contacts the electrode layer; and
a second liquid, filled in the inner space of each structural unit and not solved in the first liquid to each other, so as to form a liquid interface.

10. The optical deflecting panel of claim 9, wherein the first electrode sandwiched wall comprises:
a first inner insulating wall, on the insulating layer, extending upward;
a first electrode wall, on the first inner insulating layer; and
a first outer insulating wall, on the first electrode wall, wherein the first electrode wall is sandwiched between the first inner insulating wall and the first outer insulating wall;
wherein the second electrode sandwiched wall comprises:
a second inner insulating wall, on the insulating layer, extending upward;
a second electrode wall, on the second inner insulating layer; and
a second outer insulating wall, on the second electrode wall at an outer side, wherein the second electrode wall is sandwiched between the second inner insulating wall and the second outer insulating wall.

11. The optical deflecting panel of claim 10, wherein each of the structural units further includes an insulating wall, coupled with the first electrode sandwiched wall and the second electrode sandwiched wall to form the inner space as a close space, so that the liquids in each structure unit are separate.

12. The optical deflecting panel of claim 10, wherein each of the structural units further includes an insulating wall, coupled with the first electrode sandwiched wall and the second electrode sandwiched wall to form the inner space as an open space, extending to the outer wall.

13. The optical deflecting panel of claim 10, wherein the first liquid and the second liquid are water and oil.

14. The optical deflecting panel of claim 10, wherein in each structural unit, the electrode layer is used as a common electrode, coupled with the first electrode sandwiched wall and the second electrode sandwiched wall to produce a voltage bias, for controlling a tilting state of the liquid interface.

15. The optical deflecting panel of claim 10, wherein in each structural unit, the electrode layer has a reflection layer or the electrode layer is a metal layer, so as to have capability for reflecting light.

16. The optical deflecting panel of claim 10, wherein in each structural unit, the substrate, the electrode layer and the top cap layer are light transparent.

17. The optical deflecting panel of claim 10, receiving an incident light and allowing a portion of the incident light to transmit and be deflected.

18. The optical deflecting panel of claim 10, wherein a tilting state of the liquid interface for each structural unit is separately controlled.

19. The optical deflecting panel of claim 10, wherein a light inlet of each of the structural units for receiving the incident light is coated with IR reflection film, UV reflection film, or both IR reflection film and UV reflection film.

20. An optical deflecting panel, comprising:
a plurality of liquid optical deflectors arranged in an array, each of the liquid optical deflectors receives an incident light, wherein the incident light is divided by a tilting state of a liquid interface in each of the liquid optical deflectors into a transmitting light at first direction and a reflection light at a second direction.

21. The optical deflecting panel of claim 20, wherein a light inlet of each of the liquid optical deflectors for receiving the incident light is coated with IR reflection film, UV reflection film, or both IR reflection film and UV reflection film.

22. An optical deflector, comprising:
a first substrate;
a first electrode layer, disposed on the first substrate;
a second substrate;
a second electrode layer, disposed on the second substrate;
a first insulating layer, disposed on a predetermined peripheral region of the first electrode layer, exposing a central region of the first electrode layer;
a second insulating layer, disposed on a predetermined peripheral region of the second electrode layer, exposing a central region of the second electrode layer;
a first electrode sandwiched wall, disposed between the first insulating layer and the second insulating layer;
a second electrode sandwiched wall, disposed between the first insulating layer and the second insulating layer, against the first electrode sandwiched wall, wherein an inner space is formed between the first electrode sandwiched wall and the second sandwiched wall;
a first liquid, filled in the inner space;
a second liquid, filled in the inner space;
a third liquid, filled in the inner space between the first liquid and the second liquid without solving to each other, so as to form a first liquid interface and a second liquid interface.

23. The optical deflector of claim 22, further comprising an insulating wall, connected with the first electrode sandwiched wall and the second electrode sandwiched wall to form the inner space in a closed space.

24. The optical deflector of claim 22, further comprising an outer wall and an insulating wall, wherein the insulating wall with the first electrode sandwiched wall and the second electrode sandwiched wall to form the inner space in an open space extending to the outer wall.

25. The optical deflector of claim 22, wherein the first liquid and the second liquid are electrically conductive and the third liquid is electrically insulating.

26. The optical deflector of claim 22,
wherein the first electrode sandwiched wall comprises:
a first outer insulating wall, between the first insulating layer and the second insulating layer; and
a first electrode wall and a second electrode wall, disposed on the outer insulating wall, respectively together with the first electrode layer and the second electrode layer to have a first voltage and a second voltage;
wherein the second electrode sandwiched wall comprises:
a second outer insulating wall, between the first insulating layer and the second insulating layer; and
a third electrode wall and a fourth electrode wall, disposed on the outer insulating wall, respectively together with the first electrode layer and the second electrode layer to have a third voltage and a fourth voltage.

27. The optical deflector of claim 26, wherein the first electrode sandwiched wall further comprises a first inner insulating wall between the first insulating layer and the second insulating layer, so that the first electrode wall and the second electrode are sandwiched therebetween,
wherein the second electrode sandwiched wall further comprises a second inner insulating wall between the first insulating layer and the second insulating layer, so that the third electrode wall and the fourth electrode are sandwiched therebetween.

28. An optical deflecting panel, comprising:
a first substrate;
a first electrode layer, disposed on the first substrate;
a second substrate;
a second electrode layer, disposed on the second substrate;
a plurality of first electrode sandwiched walls, disposed between the first insulating layer and the second insulating layer;
a plurality of second electrode sandwiched walls, disposed between the first insulating layer and the second insulating layer, respectively against the first electrode sandwiched walls to form a plurality of structural units, wherein each of the structural units has an inner space;
a first liquid, filled in the inner space of each of the structural units;
a second liquid, filled in the inner space of each of the structural units;
a third liquid, filled in the inner space of each of the structural units between the first liquid and the second liquid without solving to each other, so as to form a first liquid interface and a second liquid interface.

29. The optical deflecting panel of claim 28, wherein the first liquid and the second liquid are electrically conductive and the third liquid is electrically insulative.

30. The optical deflecting panel of claim 28, wherein each of the first electrode sandwiched walls and each of the second electrode sandwiched walls comprises:
a first insulating layer and a second insulating layer, respectively disposed on the first electrode layer and the second electrode layer;
an outer insulating wall, disposed between the first insulating layer and a second insulating layer; and
a first electrode wall and a second electrode wall, disposed on the outer insulating wall, respectively together with the first electrode layer and the second electrode layer to have a first voltage and a second voltage.

31. The optical deflecting panel of claim 30, wherein each of the first electrode sandwiched walls and each of the second electrode sandwiched walls further comprises:
an inner insulating wall, disposed between the first insulating layer and a second insulating layer, the first electrode wall and the second electrode wall respectively sandwiching between the inner insulating wall and the outer insulating wall.

32. The optical deflecting panel of claim 28, wherein each of the structural units further comprises a plurality of insulating walls respectively connected with the first electrode sandwiched wall and the second electrode sandwiched wall to form the inner space in a close space.

33. The optical deflecting panel of claim 28, wherein each of the structural units further comprises a plurality of insulating walls respectively with the first electrode sandwiched wall and the second electrode sandwiched wall to form the inner space in an open space, extending to the outer wall.
